(19) United States
(12) Patent Application Publication
(10) Pub. No.: US 2005/0019563 A1
(43) Pub. Date: Jan. 27, 2005

(54) GLYOXAL CROSSLINKED CELLULOSIC FIBERS HAVING HIGH BULK

(75) Inventors: Angel Stoyanov, Seattle, WA (US); Shahrokh Naieni, Seattle, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Company

(21) Appl. No.: 10/627,067

(22) Filed: Jul. 25, 2003

(51) Int. Cl. B32B 23/02

(52) U.S. Cl. 428/364; 442/334; 442/394; 428/34.2; 428/357

(57) ABSTRACT

Glyoxal crosslinked cellulosic fibers having high wet bulk, and methods for making the fibers.

### FIELD OF THE INVENTION

The present invention relates generally to cellulosic fibers and, more specifically, to glyoxal crosslinked cellulosic fibers having high bulk.

### BACKGROUND OF THE INVENTION

Cellulosic fibers are a basic component of absorbent products such as diapers. Although absorbent, cellulosic fibers tend to collapse on wetting, they retain absorbed liquid and consequently suffer from diminished liquid acquisition rate in absorbent products. The inability of wetted cellulosic fibers in absorbent products to further acquire liquid and to distribute liquid to sites remote from liquid insult can be attributed in part to the loss of fiber bulk associated with liquid absorption. An absorbent product's ability to acquire and distribute liquid will generally depend on the product's bulk and capillary structure. The ability of a product to further acquire liquid on subsequent insults will depend on the product's wet bulk. Absorbent products made from cellulosic fluff pulp, a form of cellulosic fibers having an extremely high void volume, lose bulk on liquid acquisition and the ability to further wick and acquire liquid, causing local saturation.

Crosslinked cellulosic fibers generally have enhanced wet bulk compared to uncrosslinked fibers. The enhanced bulk is a consequence of the stiffness, twist, and curl imparted to the fiber as a result of crosslinking. Accordingly, crosslinked fibers are advantageously incorporated into absorbent products to enhance their wet bulk and liquid acquisition rate and to also reduce rewet.

Because absorbent products ideally rapidly acquire liquid, effectively distribute liquid to sites remote from insult, continue to acquire liquid on subsequent insult, and have low rewet, there exists a need for cellulosic fibers having wet bulk sufficient to achieve these ideal properties. The present invention seeks to fulfill these needs and provides further related advantages.

### SUMMARY OF THE INVENTION

In one aspect, the present invention provides individualized cellulosic fibers having high wet bulk. The high wet bulk cellulosic fibers of the invention are intrafiber crosslinked cellulosic fibers obtainable from cellulosic fibers by treatment with glyoxal. The cellulosic fibers of the invention are crosslinked by treatment with only an aqueous glyoxal solution (e.g., without a crosslinking catalyst). The fibers of the present invention have a wet bulk greater than about 20 cm³/g at 0.6 kPa.

In another aspect of the invention, methods for the preparation of cellulosic fibers having high wet bulk are provided. In the methods, a fibrous web of cellulosic fibers is treated with only an aqueous glyoxal solution (e.g., without a crosslinking catalyst), wet fiberized, and then dried and cured to provide individualized cellulosic fibers having high wet bulk.

### DETAILED DESCRIPTION OF THE PREFERRED EMBODIMENT

The present invention provides cellulosic fibers having high bulk and methods for their preparation. The fibers of the invention are glyoxal crosslinked cellulosic fibers. The glyoxal crosslinked cellulosic fibers are intrafiber crosslinked fibers. The glyoxal crosslinked cellulosic fibers are made by treatment with an amount of glyoxal effective to provide crosslinked fibers having a wet bulk greater than about 20 cm³/g at 0.6 kPa.

As used herein, the term “bulk” refers to the volume in cubic centimeters occupied by 1.0 gram of airlaid fluff pulp under a load of 0.6 kPa. The term “wet bulk” refers to the volume in cubic centimeters occupied by 1.0 gram (dry basis) of fluff pulp under load of 0.6 kPa after the bulk has been wetted with water. Wet bulk underload is measured by the Fiber Absorption Quality (FAQ) Analyzer (Weyerhaeuser Co., Federal Way, Wash.) and reported in cm³/g at 0.6 kPa as described below.

In one embodiment, the glyoxal crosslinked fibers have a wet bulk greater than about 20 cm³/g at 0.6 kPa. In another embodiment, the glyoxal crosslinked fibers have a wet bulk greater than about 22 cm³/g at 0.6 kPa. In another embodiment, the glyoxal crosslinked fibers have a wet bulk greater than about 25 cm³/g at 0.6 kPa. The bulk of representative glyoxal crosslinked cellulosic fibers of the invention as a function of crosslinking time and temperature is presented in Table 1. In addition to high bulk, the glyoxal crosslinked fibers of the invention advantageous exhibit high brightness compared to other high bulk fibers. The bulk and brightness of representative glyoxal crosslinked cellulosic fibers of the invention as a function of crosslinking time and temperature is presented in Table 2.

The high wet bulk cellulosic fibers of the invention are glyoxal crosslinked cellulosic fibers. As used herein, the term “glyoxal crosslinked cellulosic fibers” refers to cellulosic fibers obtainable from cellulose fibers by treatment with an aqueous glyoxal solution without the use of a crosslinking catalyst. The glyoxal crosslinked fibers of the invention are intrafiber crosslinked fibers.

The glyoxal crosslinked cellulosic fibers of the invention are made by treating a mat or web of cellulosic fibers with an aqueous glyoxal solution to provide glyoxal treated fibers, which are then separated into individual glyoxal treated fibers, and heated for a time and at a temperature to effect curing (i.e., to provide glyoxal crosslinked cellulosic fibers). The glyoxal crosslinked fibers of the invention are made by treatment with an aqueous glyoxal solution without the use of a crosslinking catalyst. Representative methods for making the glyoxal crosslinked cellulosic fibers of the invention are described in Example 1.

The preparation of cellulosic fibers crosslinked with glyoxal using a crosslinking catalyst is described in Example 2. The crosslinking procedure described in Example 2 is as described in Example 1 of U.S. Pat. No. 4,888,093, Individualized Crosslinked-Fibers and Process for Making Said Fibers. The crosslinked cellulosic fibers prepared as described in Example 2 had a bulk significantly lower than the bulk of the glyoxal crosslinked fibers of the invention. In contrast to the glyoxal crosslinked cellulosic fibers of the invention having a bulk greater than about 20 cm³/g at 0.6 kPa, the highest bulk achieved for the fibers crosslinked with glyoxal and crosslinking catalyst was about 13 cm³/g at 0.6 kPa. The crosslinked cellulosic fibers prepared as described in Example 2 had a brightness significantly lower than the brightness of the glyoxal crosslinked fibers of the invention. In contrast to the glyoxal crosslinked cellulosic fibers of the invention having a brightness greater than about 80% ISO, the highest brightness achieved for the fibers crosslinked with glyoxal and crosslinking catalyst was about 74% ISO.

In another aspect, the present invention provides cellulosic fibers crosslinked by treatment with an aqueous glyoxal solution without the use of a crosslinking catalyst. In the method for making glyoxal crosslinked cellulosic fibers, cellulosic fibers to be crosslinked are treated with an aqueous glyoxal solution. The fibers are treated with an effective amount of glyoxal to achieve the wet bulk enhancement described herein. Generally, the fibers are treated with from about 4 to about 15 percent by weight glyoxal based on the total weight of the treated fibers. In one embodiment, the fibers are treated with from about 6 to about 10 percent by weight based on the weight of fibers.

In general, the cellulose fibers of the present invention may be prepared by a system and apparatus as described in U.S. Pat. No. 5,447,977 to Young, Sr. et al., which is incorporated herein by reference in its entirety. Briefly, the fibers are prepared by a system and apparatus that includes a conveying device for transporting a mat or web of cellulose fibers through a fiber treatment zone; an applicator for applying a treatment substance such as an aqueous glyoxal solution from a source to the fibers at the fiber treatment zone; a fiberizer for separating the individual cellulose fibers comprising the mat to form a fiber output comprised of substantially unbroken and essentially singulated cellulose fibers; a dryer coupled to the fiberizer for flash evaporating residual moisture; and a controlled temperature zone for additional heating of fibers and an oven for curing the crosslinking agent, to form dried and cured individualized crosslinked fibers.

As used herein, the term “mat” refers to any nonwoven sheet structure comprising cellulose fibers or other fibers that are not covalently bound together. The fibers include fibers obtained from wood pulp or other sources including cotton rag, hemp, grasses, cane, husks, cornstalks, or other suitable sources of cellulose fibers that may be laid into a sheet. The mat of cellulose fibers is preferably in an extended sheet form, and may be one of a number of baled sheets of discrete size or may be a continuous roll.

Each mat of cellulose fibers is transported by a conveying device, for example, a conveyor belt or a series of driven rollers. The conveying device carries the mats through the fiber treatment zone.

At the fiber treatment zone, an aqueous glyoxal solution is applied to the cellulose fibers. The solution is preferably applied to one or both surfaces of the mat using any one of a variety of methods known in the art, including spraying, rolling, or dipping. Once the glyoxal solution has been applied to the mat, the solution may be uniformly distributed through the mat, for example, by passing the mat through a pair of rollers.

After the fibers have been treated with the crosslinking agent, the impregnated mat is fiberized by feeding the mat through a hammermill. The hammermill serves to disintegrate the mat into its component individual cellulose fibers, which are then air conveyed through a drying unit to remove the residual moisture. In a preferred embodiment, the fibrous mat is wet fiberized.

The pulp is then air conveyed through an additional heating zone to bring the temperature of the pulp to the cure temperature. The cure temperature for glyoxal is about 150° C. In one embodiment, the dryer comprises a first drying zone for receiving the fibers and for removing residual moisture from the fibers via a flash-drying method, and a second heating zone for curing the crosslinking agent. Alternatively, in another embodiment, the treated fibers are blown through a flash-dryer to remove residual moisture, heated to a curing temperature, and then transferred to an oven where the treated fibers are subsequently cured. Overall, the treated fibers are dried and then cured for a sufficient time and at a sufficient temperature to effect crosslinking. Typically, the fibers are oven-dried and cured for about 3 to about 10 minutes at a temperature from about 135° C. to about 165° C. In one embodiment, the fibers are dried and cured at about 150° C. to about 157° C.

As noted above, the present invention relates to crosslinked cellulose fibers. Although available from other sources, cellulosic fibers useful for making glyoxal crosslinked cellulosic fibers of the invention are derived primarily from wood pulp. Suitable wood pulp fibers for use with the invention can be obtained from well-known chemical processes such as the kraft and sulfite processes, with or without subsequent bleaching. The pulp fibers may also be processed by thermomechanical, chemithermomechanical methods, or combinations thereof. The preferred pulp fiber is produced by chemical methods. Ground wood fibers, recycled or secondary wood pulp fibers, and bleached and unbleached wood pulp fibers can be used. The preferred starting material is prepared from long-fiber coniferous wood species, such as southern pine, Douglas fir, spruce, and hemlock. Details of the production of wood pulp fibers are well-known to those skilled in the art. These fibers are commercially available from a number of companies, including Weyerhaeuser Company. For example, suitable cellulose fibers produced from southern pine that are usable with the present invention are available from Weyerhaeuser Company under the designations CF416, NF405, PL416, FR416, FR516, and NB416.

The wood pulp fibers useful in the present invention can also be pretreated prior to use with the present invention. This pretreatment may include physical treatment, such as subjecting the fibers to steam or chemical treatment. Although not to be construed as a limitation, examples of pretreating fibers include the application of fire retardants to the fibers, and surfactants or other liquids, such as solvents, which modify the surface chemistry of the fibers. Other pretreatments include incorporation of antimicrobials, pigments, and densification or softening agents. Fibers pretreated with other chemicals, such as thermoplastic and thermosetting resins also may be used. Combinations of pretreatments also may be employed.

Method for determining fiber wet bulk, absorption time, absorption rate, and capacity.

The wet bulk, absorption time, absorption rate, and capacity of cellulosic fibers crosslinked with glyoxal of the invention was determined by the Fiber Absorption Quality (FAQ) Analyzer (Weyerhaeuser Co., Federal Way, Wash.) using the following procedure.

In the procedure, a 4-gram sample of the pulp fibers is put through a pinmill to open the pulp and then airlaid into a tube. The tube is then placed in the FAQ Analyzer. A plunger then descends on the fluff pad at a pressure of 0.6 kPa and the pad height bulk determined. The weight is increased to achieve a pressure of 2.5 kPa and the bulk recalculated. The result, two bulk measurements on the dry fluff pulp at two different pressures. While under the 2.5 kPa pressure, water is introduced into the bottom of the tube (bottom of the pad). The time required for the water to reach the plunger is measured. From this, the absorption time and absorption rate are determined. The final bulk of the wet pad at 2.5 kPa is also measured. The plunger is then withdrawn from the tube and the wet pad allowed to expand for 60 seconds. The plunger is reapplied at 0.6 kPa and the bulk determined. The final bulk of the wet pad at 0.6 kPa is considered the wet bulk (cm³/g) of the pulp product.

Method for determining fiber brightness.

The brightness (% ISO) of cellulosic fibers crosslinked with glyoxal was determined according to TAPPI T 525 om-02 on a Technibrite MicroTB-1C instrument (Technydine Corp.) As used herein, the term “brightness” refers to the reflectance of blue light corresponding to a centroid wavelength of 457 nm in terms of the perfect reflecting diffuser (perfect reflecting diffuser is the ideal reflecting surface that neither absorbs nor transmits light, but reflects diffusely, with the radiance of the reflecting surface being the same for all reflecting angles, regardless of the angular distribution of the incident light).

The glyoxal crosslinked cellulosic fibers of the present invention can be advantageously incorporated into an absorbent product to impart wet bulk to the product. Such products can further include other fibers such as fluff pulp fibers, synthetic fibers, other crosslinked fibers, and absorbent materials such as superabsorbent polymeric materials. Representative absorbent products that can include the glyoxal crosslinked fibers of the invention include infant diapers, adult incontinence products, and feminine hygiene products. The glyoxal crosslinked fibers can be included in liquid acquisition, distribution, or storage layers to provide products having superior liquid acquisition rates, liquid distribution, and rewet properties. The glyoxal crosslinked cellulosic fibers of the present invention can be advantageously incorporated into tissue and towel products.

The glyoxal crosslinked fibers of the invention can be advantageously incorporated into paperboard products, including single and multi-ply paperboard products. Paperboard products that include the glyoxal crosslinked fibers can be used in insulation applications, for example, insulated cups and containers. Paperboard products that include the glyoxal crosslinked fibers can also be used as packaging materials.

The glyoxal crosslinked cellulosic fibers of the invention are essentially odorless. This is in contrast to cellulosic fibers that have been modified with polycarboxylic acid crosslinking agents such as citric acid crosslinked cellulosic fibers.

The bulk of representative glyoxal crosslinked fibers of the invention as a function of glyoxal addition, cure temperature, and cure time is summarized in Table 1.

TABLE 1
Bulk and Brightness for Representative Glyoxal Crosslinked Fibers.

| | | | | |
|---|---|---|---|---|
| Glyoxal | Cure Temp. | Cure time | Bulk | Brightness |

| | | | | | |
|---|---|---|---|---|---|
| (%) | (° C.) | (° F.) | (min.) | (cm³/g) | (% ISO) |

| | | | | | |
|---|---|---|---|---|---|
| 6 | 140 | 284 | 5 | 20.2 | 87.4 |
| 6 | 140 | 284 | 7 | 21.7 | 86.7 |
| 6 | 140 | 284 | 10 | 21.3 | 84.0 |
| 6 | 150 | 302 | 5 | 21.2 | 86.2 |
| 6 | 150 | 302 | 7 | 21.9 | 83.1 |
| 6 | 150 | 302 | 10 | 22.0 | 79.6 |
| 7 | 140 | 284 | 5 | 21.7 | 87.1 |
| 7 | 140 | 284 | 7 | 22.4 | 86.4 |
| 7 | 140 | 284 | 10 | 22.1 | 85.3 |
| 7 | 150 | 302 | 5 | 21.9 | 85.4 |
| 7 | 150 | 302 | 7 | 22.8 | 84.6 |
| 7 | 150 | 302 | 10 | 22.4 | 79.2 |
| 8 | 140 | 284 | 5 | 23.2 | 87.7 |
| 8 | 140 | 284 | 7 | 22.9 | 85.7 |
| 8 | 140 | 284 | 10 | 23.2 | 84.2 |
| 8 | 150 | 302 | 5 | 22.8 | 85.7 |
| 8 | 150 | 302 | 7 | 23.6 | 83.5 |
| 8 | 150 | 302 | 10 | 24.2 | 79.6 |
| 9 | 140 | 284 | 5 | 23.1 | 87.4 |
| 9 | 140 | 284 | 7 | 23.7 | 86.2 |
| 9 | 140 | 284 | 10 | 24.6 | 85.6 |
| 9 | 150 | 302 | 5 | 23.0 | 85.2 |
| 9 | 150 | 302 | 7 | 24.8 | 82.7 |
| 9 | 150 | 302 | 10 | 24.9 | 80.5 |
| 10 | 140 | 284 | 5 | 23.8 | 87.9 |
| 10 | 140 | 284 | 7 | 24.3 | 85.9 |
| 10 | 140 | 284 | 10 | 25.9 | 85.0 |
| 10 | 150 | 302 | 5 | 24.2 | 86.0 |
| 10 | 150 | 302 | 7 | 25.3 | 83.7 |
| 10 | 150 | 302 | 10 | 26.3 | 79.8 |

The bulk and brightness of representative glyoxal crosslinked fibers of the invention as a function of glyoxal addition, cure temperature, and cure time are summarized in Table 2.

TABLE 2
Bulk for Representative Glyoxal Crosslinked Fibers.

| Glyoxal | Temperature | Time | Bulk |
|---|---|---|---|
| (%) | (° C.) | (min) | (cm³/g) |
| 3 | 135 | 5 | 17.9 |
| 3 | 150 | 5 | 18.3 |
| 3 | 150 | 7 | 18.4 |
| 3 | 150 | 5 | 18.6 |
| 3 | 150 | 3 | 18.2 |
| 3 | 163 | 5 | 18.2 |
| 6 | 163 | 3 | 21.4 |
| 6 | 163 | 7 | 22.1 |
| 6 | 150 | 5 | 21.8 |
| 6 | 150 | 5 | 21.5 |
| 6 | 150 | 5 | 21.5 |
| 6 | 135 | 7 | 20.9 |
| 6 | 135 | 3 | 20.6 |
| 9 | 135 | 5 | 21.7 |
| 9 | 150 | 7 | 23.2 |
| 9 | 150 | 3 | 22.7 |
| 9 | 163 | 5 | 23.6 |

The present invention provides high wet bulk cellulosic fibers having wet bulks greater than about 20 cm3/g at 0.6 kPa. The fibers of the invention are intrafiber crosslinked cellulosic fibers obtainable from cellulosic fibers by treatment with an aqueous glyoxal solution. The fibers can be formed from cellulosic fibers by treatment with an amount of glyoxal without the use of a crosslinking catalyst effective to provide the wet bulk enhancement described herein.

The following examples are for the purposes of illustrating, not limiting, the present invention.

### EXAMPLES

### Example 1

### Representative Glyoxal Crosslinked Cellulosic Fibers

In this example, methods for forming representative high bulk fibers in accordance with the present invention are described.

Method A.

A selected amount of glyoxal (CARTABOND GHF containing 40 percent by weight glyoxal in water) was applied to both sides of a twenty gram pulp sheet (NF405, dried wood pulp fibers available from Weyerhaeuser Co.) using a 5 mL disposable syringe and 23.1 gauge needle. The sample was held in a resealable plastic bag for 16-18 hours at room temperature, then broken into pieces (e.g., about 2×2 cm), passed through a laboratory fiberizer, and collected as a loose pad. The pad was broken into small pieces (e.g., about 3×3 cm), placed into a screen basket and cured at a fixed temperature and time in a Despatch V Series oven.

Glyoxal crosslinked fibers prepared by this method had the bulk described in Table 1.

Method B.

Pulp sheets in roll form (NF405, dried wood pulp fibers available from Weyerhaeuser Co.) were treated with glyoxal (commercially available under the designation CARTABOND GHF from Clariant Corp.) according to the following procedure. The pulp sheet was fed from the roll through a constantly replenished bath of the crosslinking solution (i.e., an aqueous solution containing a glyoxal concentration determined by the weight add-on desired), then through a roll nip set to remove sufficient solution so that the pulp sheet after treating was at about 40% moisture content. The concentration of the bath was adjusted to achieve the desired level of chemical addition to the pulp sheet. After the roll nip, the wet sheet was fed through a hammer mill to fiberize the pulp. The individualized fibers were then blown through a flash dryer to affect drying and then to a cyclone where the treated cellulose fluff was separated from the air stream. The pulp was air conveyed through an additional heating zone to bring the temperature of the pulp to the cure temperature and then transferred to an oven where the treated fibers were subsequently cured.

Glyoxal crosslinked fibers prepared by this method had the bulk and brightness described in Table 2.

### Example 2

### Comparative Example

### Bulk and Brightness for Cellulose Fibers Crosslinked with Glyoxal Using Catalyst

In this example, the bulk and brightness of cellulose fibers crosslinked with glyoxal and catalyst is described. Wood pulp fibers (never-dried FR416 available from Weyerhaeuser Company) were treated with glyoxal and crosslinking catalyst, zinc nitrate hexahydrate, 30 weight percent based on the weight of glyoxal, according to the procedure described in U.S. Pat. No. 4,888,093, Individualized Crosslinked-Fibers and Process for Making Said Fibers, Example 1. The only difference was that only one of the solutions was adjusted to 3.7 because all others were below this value.

The fibers were treated with 3, 6, and 9 weight percent glyoxal and catalyst, and cured (145° C., 45 min) to provide glyoxal crosslinked fibers. The bulk (cm³/g) and brightness (% ISO) for the glyoxal crosslinked fibers is summarized in Table 3.

TABLE 3
Bulk and Brightness for Glyoxal/Catalyst Crosslinked Fibers

| Glyoxal | Bulk | Brightness |
|---|---|---|
| (wt %) | (cm³/g) | (% ISO) |
| 3 | 12.1 | 73.2 |
| 6 | 12.7 | 65.6 |
| 6* | 12.7 | 67.4 |
| 9 | 13.2 | 60.6 |

*The pH was adjusted to around 3.7 (as described in the '093 patent) with NaOH. The pH of the other three samples was 2.74, 2.50, and 2.27 as-is, respectively.

The pH of the other three samples was 2.74, 2.50, and 2.27 as-is, respectively.

As shown in Table 3, bulk increases with increasing glyoxal amount, and brightness decreases with increasing glyoxal amount.

While the preferred embodiment of the invention has been illustrated and described, it will be appreciated that various changes can be made therein without departing from the spirit and scope of the invention.

1. Individualized, crosslinked cellulosic fibers, comprising cellulosic fibers treated with only an aqueous glyoxal solution in an amount effective to provide crosslinked fibers having a wet bulk greater than about 20 cm³/g at 0.6 kPa.

2. The fibers of claim 1, wherein the wet bulk is greater than about 22 cm³/g at 0.6 kPa.

3. The fibers of claim 1, wherein the wet bulk is greater than about 25 cm³/g at 0.6 kPa.

4. The fibers of claim 1, wherein the fibers have a brightness greater than about 80% ISO.

5. The fibers of claim 1, wherein the amount of glyoxal is from about 4 to about 15 percent by weight based on the weight of fibers.

6. The fibers of claim 1, wherein the amount of glyoxal is from about 6 to about 10 percent by weight based on the weight of fibers.

7. An absorbent product, comprising cellulosic fibers treated with only an aqueous glyoxal solution in an amount effective to provide crosslinked fibers having a wet bulk greater than about 20 cm³/g at 0.6 kPa.

8. The product of claim 7, wherein crosslinked fibers have a wet bulk is greater than about 22 cm³/g at 0.6 kPa.

9. The product of claim 7, wherein the crosslinked fibers have a wet bulk is greater than about 25 cm³/g at 0.6 kPa.

10. The product of claim 7 further comprising fluff pulp fibers.

11. The product of claim 7 further comprising superabsorbent material.

12. The product of claim 7, wherein the product is an infant diaper.

13. The product of claim 7, wherein the product is an adult incontinence product.

14. The product of claim 7, wherein the product is a feminine hygiene product.

15. The product of claim 7, wherein the product is at least one of a tissue or towel.

16. A paperboard product, comprising cellulosic fibers treated with only an aqueous glyoxal solution in an amount effective to provide crosslinked fibers having a wet bulk greater than about 20 cm³/g at 0.6 kPa.

17. The product of claim 16, wherein crosslinked fibers have a wet bulk is greater than about 22 cm³/g at 0.6 kPa.

18. The product of claim 16, wherein the crosslinked fibers have a wet bulk is greater than about 25 cm³/g at 0.6 kPa.

19. The product of claim 16, wherein the product is an insulated paperboard.

20. The product of claim 16, wherein the product is a packaging material.
